(19) United States
(12) Patent Application Publication
(10) Pub. No.: US 2019/0324631 A1
(43) Pub. Date: Oct. 24, 2019

(54) Multiple Segment Switch Assignment

(71) Applicant: Sanjay Patel, Raleigh, NC (US)

(72) Inventor: Sanjay Patel, Raleigh, NC (US)

(21) Appl. No.: 15/957,957

(22) Filed: Apr. 20, 2018

(51) Int. Cl. G06F 3/0484; G06F 3/0482

(52) U.S. Cl. CPC G06F 3/04847; G06F 3/0482

(57) ABSTRACT

This document presents a system and method for assessing the state of an electric switch cover that is configured to control one, two or four separate control circuits upon the user depressing an electric switch cover portion associated with the switch area for each control circuit. Each time a user depresses the electric switch cover portion, a pressure signal is sent to a processor installed within the switch identifying the electric circuit associated with that portion of the electric switch cover. The processor determines the configuration of devices, experiences, and/or triggers associated with the selected electric circuit and sends an activation signal through the electric circuit. A user thus may customize the control of multiple configurable devices and experiences in any space in a user's home.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Automation provides many opportunities to create system level actions and functions that are activated by a user to better control their environment. Such systems are installed in homes and other buildings to permit one or more users to customize the environment for their liking or for functions, moods, or experiences that may take place in the space into which the automation system has been installed. Master controllers may also provide the users of a building or home space to control functions from within the space, or outside of the space through the use of networking and wireless technology.

Numerous functions being activated can overwhelm existing home and office wiring and make it difficult to install new functions into existing spaces economically and efficiently. Optimizing the existing infrastructure can create opportunities to save time and space by not having to remove existing wiring and other infrastructure to install new functionality.

Light switch covers are generally available to keep dust and dirt from entering the light switch mechanism and to provide some switching capability. Many switch covers have integrated elements to permit a user to locate them in low light conditions, and to provide for actions that a user may initiate by pressing on the light cover.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a processor circuit board having a connection to a plurality of light emitting elements consistent with certain embodiments of the present invention.

FIG. 2 is a view of a light restriction template consistent with certain embodiments of the present invention.

FIG. 3 is a view of a view of an electronic switch cover having light bar elements consistent with certain embodiments of the present invention.

FIG. 4 is a view of the light restriction template in contact with the processor circuit board consistent with certain embodiments of the present invention.

FIG. 5 is a flow diagram for operation of the light bar activation when a user touches the light bar switch cover consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to an “illumination element” refers to a physical element that emits visible light when activated. Such illumination elements include, but are not limited to, LEDs, LCDs, incandescent lights, and any other device suitable for emitting visible light when activated.

Reference throughout this document to a “light bar” refers to a switch element that permits emitted light to be constrained to a rectangular illumination window regardless of the physical configuration of the illumination element.

Many light switches provide an illumination solution such that the switch plate may be located by a user in low light conditions. However, knowing the status of a light switch for switches that may activate and/or control multiple switching circuits from a single light switch is difficult to determine whether in low light conditions or in normal light conditions. A single switch with multiple control positions, such as switches that may control three-way or four-way switching circuits, dimming functions, or switches that may be programmable to permit multiple switching functions may require a plurality of illumination elements to permit a user to determine what state or function is the current setting for the switch in low light conditions.

In an embodiment, a switch configured to control a plurality of electrical circuits that in turn activate devices attached to the plurality of electrical circuits may have two or more light bars. The light bars may be configured to activate or deactivate through a user touching or putting pressure on a switch cover. Touching or putting pressure on a switch cover may be captured by a pressure sensitive component associated with the switch and configured to be placed below the switch cover. As a user depresses or puts pressure on the switch cover, the pressure sensitive component relays the indication of pressure to a processor device installed within the body of the switch. Each application of force, through the pressure applied by the user, is captured by the pressure sensitive component and relayed to the processor device.

In an embodiment, when the indication of a pressure event is received by the processor device, the processor device is active to first determine the existing state of the electrical switch. The existing state may indicate the electrical circuits associated with the electrical switch that are currently active and the illumination elements that are currently on, indicating to a user at a glance which devices may be active because the user associates an electrical circuit with those devices that are controlled by activating or deactivating that electrical circuit.

In an embodiment, portions of the cover of the electrical switch may be defined as buttons. Each defined button may be assigned an action, or a mood, or an experience that will be activated when the user touches the button portion of the electrical switch cover. In this non-limiting example, button assignments may be created using the following steps. From the home menu select a “lighting” icon from the Graphical User Interface (GUI). The GUI will present the user with the option to assign actions, such as the activation of electronic equipment and sensors or activation of moods and experiences, to one or more defined sections of the electrical switch cover that serve as activation sections. The user may be presented with a menu of equipment items, electrical circuits, sensors, and/or moods and experiences that may be selected for association with one or more activation sections of the electrical switch cover. The user may select any element from a drop-down list, select the activation portion of the switch to which the element is to be connected and select continue to associate the element with the activation portion of the switch.

In an embodiment, the user may select button assignments for each of a plurality of electric switches, then edit one or more selected buttons. Editing may be done by selecting previously defined moods and experiences from a defined list. The moods and experiences may be added to a button through a “drag and drop” process, adding a mood or experience to the button and replacing the current configuration associated with the button. The user may then save the updated configuration and utilize the configuration with any installation of the system

In an exemplary embodiment, one or more illumination elements may be turned on, providing a visual indicator that each electrical circuit and devices associated with that electrical circuit are currently active. By way of example and not of limitation, an illumination element may be composed of one or more rectangular shaped light bars. In this exemplary configuration a light switch cover may be manufactured of a translucent material such that the light from an illumination element may shine through the light switch cover. The light bars may be configured such that all illumination elements may be off, or a single illumination element may be on to indicate that the electrical switch is ready for activation and may serve as a visual locator for the light switch. In this non-limiting example, a light bar may be configured such that it is positioned at the top of a light switch cover when that light switch cover is installed in a vertical orientation. Additional light bar elements may be configured such that they are positioned an equal separation distance along the light switch cover. This configuration permits multiple light bar elements to bracket an active portion of a switch to which multiple electrical circuits and devices are attached.

In this non-limiting example, if a light switch were configured such that four electrical circuits or devices, or four different sensors, moods or experiences were attached to the light switch and the light switch provides the activation or deactivation trigger of any one or more of the electrical circuits or devices, or four different sensors, moods or experiences, the light switch could be configured with four control zones. Upon sensing pressure from a user depressing the light switch cover, the light switch sensing the pressure of the user's action, may activate the electrical circuit or electrically connected device that may be physically associated with the light switch cover position that initiates as the active electrical circuit or device. In this manner, the programmable portion of the switch cover has been selected, light bar elements may bracket the activated section of the switch cover to indicate that the devices, sensors, moods, or experiences associated with the section of the switch cover touched by the user are actively in use.

In an embodiment, the light switch may be configured such that one or more experiences may be activated upon the selection of a control section of the light switch. The light switch may be installed and configured to permit one, two, or four separate experiences to be activated by connecting an experience action to the one, two, or four control portions of the light switch cover. In a non-limiting example, if a light switch is configured to permit the activation of four electrical circuits from the single switch, an experience may be associated with each electrical circuit. The user selection of that portion of the light switch that is configured to activate an experience associated with the electrical circuit connected to that portion of the light switch will cause the system to retrieve and initiate the experience. Additionally, each portion of the light switch may be labeled as to the electrical circuit to which it is attached or labeled with the name of the experience to be activated when that portion of the light switch is depressed by the user.

In an embodiment, a system and apparatus for providing activation actions for an electric switch and the electrical circuit associated with the activation portion of the electric switch are described having a processor associated with an integrated circuit card, the integrated circuit card installed within an electric switch. The electric switch cover may have one or more activation portions defined as portions of said electric switch cover and a sensor connected to said electronic switch cover plate and said integrated circuit to provide signals to said processor when user interaction is detected. The system may associate actions and pre-configured moods and experiences with one or more activation portions of said electric switch cover. Additionally, a module installed within the processor may be active to control and manage the activation of the one or more activation portions of said electric switch cover, and where user interaction with said one or more activation elements associated with the electric switch cover activates the action and/or mood and experience configured for said activation portion of the electric switch cover.

In an embodiment the system and apparatus may also contain illumination elements composed of LED, LCD, or any other small form factor lighting element. An electric switch cover may have the masking template positioned over the illumination elements and have two or more rectangular openings through which light from the illumination elements may pass. A sensor associated with the system and apparatus captures the interaction of a user with the electric switch cover plate when a user presses upon the electric switch cover plate with a force greater than a pre-configured force level. The management and control of the illumination elements permits horizontally oriented light bars to become visible on the surface of the electric switch cover plate, permitting a user to ascertain areas of the electric switch cover plate associated with the horizontally oriented light bars which indicate when devices, sensors, moods, or experiences connected to an area of the electric switch cover plate are active or in operation.

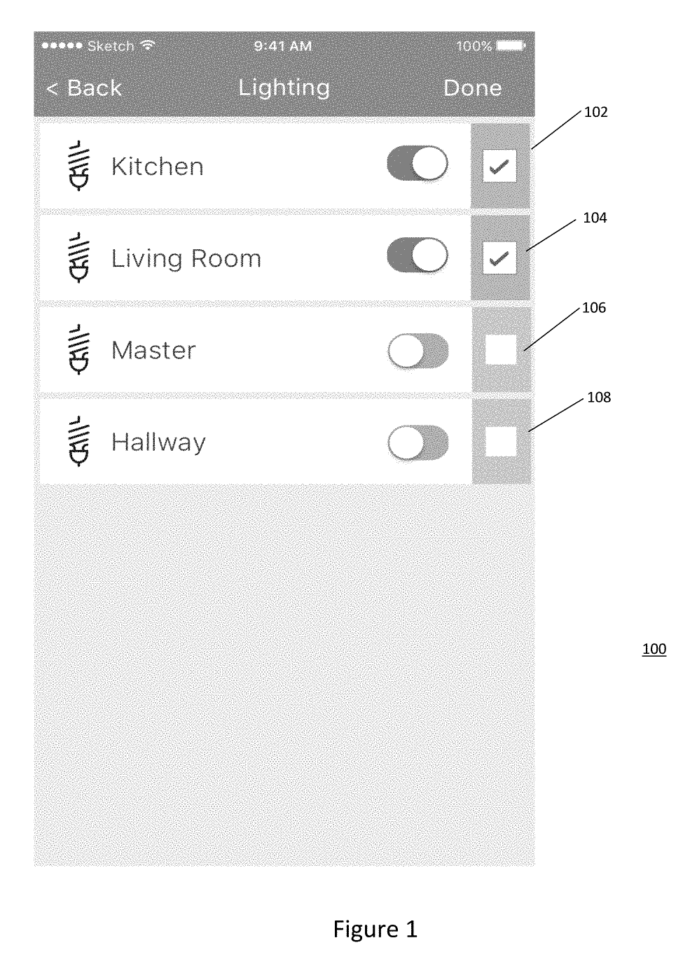

Turning now to FIG. 1, this figure presents a screen shot of the create experience function consistent with certain embodiments of the present invention. In an exemplary embodiment, a user may open the system application on any wireless device, such as an iPad, tablet, computer, smart phone, smart watch, or any other wireless connected device having a display visible to the user and select the create experience function 100. The create experience function 100 may present the user with all spaces, both interior and exterior, defined within the system for which an experience may be created. In a non-limiting example, the figure presents the Kitchen 102, Living Room 104, Master (bedroom) 106, and Hallway 108, as defined spaces in which lighting settings for an experience may be selected. Continuing in the non-limiting example, the user may select lighting in the Kitchen 102 and Living Room 104 to be a part of a defined experience. After selection the user may save the spaces defined as active for this experience.

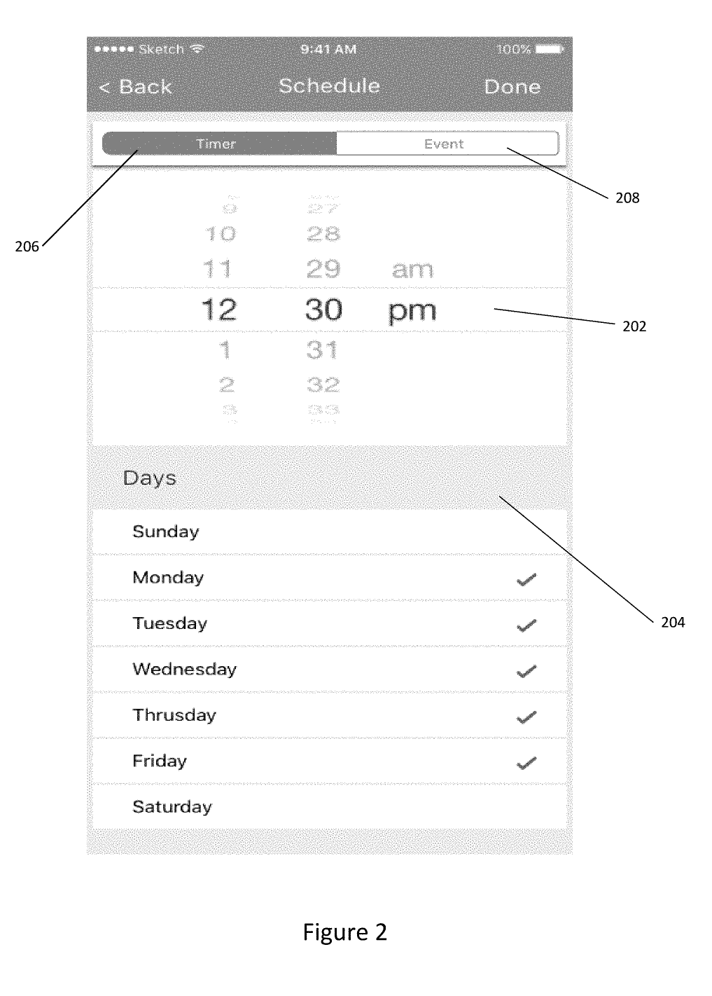

Turning now to FIG. 2, this figure presents a view of a screen shot of the create experience scheduling function consistent with certain embodiments of the present invention. In an exemplary embodiment, the user defined experience may have a timing element for the initiation of a user defined experience 200. The user may be presented with a time 202 and day display 204. The user may also select whether the experience is to be initiated based upon a timer 206 or an event 208.

The user may select the time 202 portion of the display to select the time at which the experience is to begin and place the initiation of the experience on a timer 206. The time may be selected as am or pm. The user may also select the days of the week for which this experience is to be active in the day display 204. In this non-limiting example, the user may select prefer to begin the experience at 12:30 pm, Monday through Friday. The system will then activate the elements for the experience in the spaces selected at the pre-configured time 202 and day 204.

In an alternative embodiment, the user may select an event 208 as the initiation trigger for the experience. Events 208 such as, in a non-limiting example, religious holidays, birthdays, or other celebrations may be pre-configured in the system. Upon the occurrence of the triggering event, the experience selected by the user will become active.

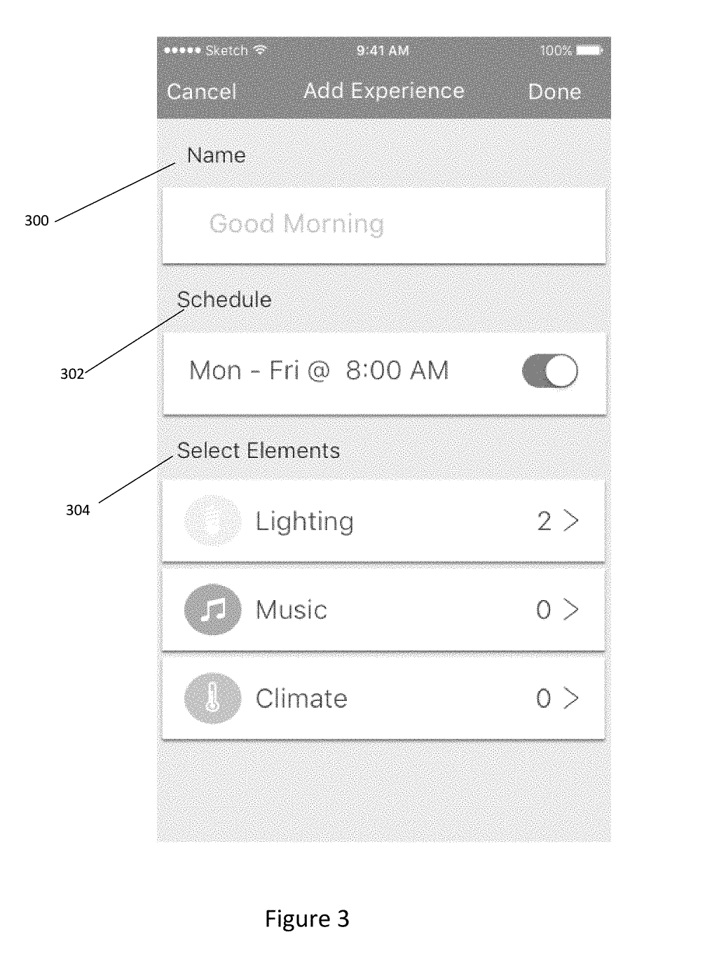

Turning now to FIG. 3, this figure presents a screen shot of the add experience function consistent with certain embodiments of the present invention. In this embodiment, the user may assign a name 300 to the defined experience. The name 300 may be saved within the system database as the identifier for the experience and recalled for later action. In a non-limiting example, the display may present to the user the name 300 of the experience in combination with the schedule 302 of when the experience is to become active, as well as the system elements within a space that are defined for the experience 304. The user may also choose to amend or change the experience by adding additional spaces, elements, and/or updating the day and time prior to saving the experience under the selected name.

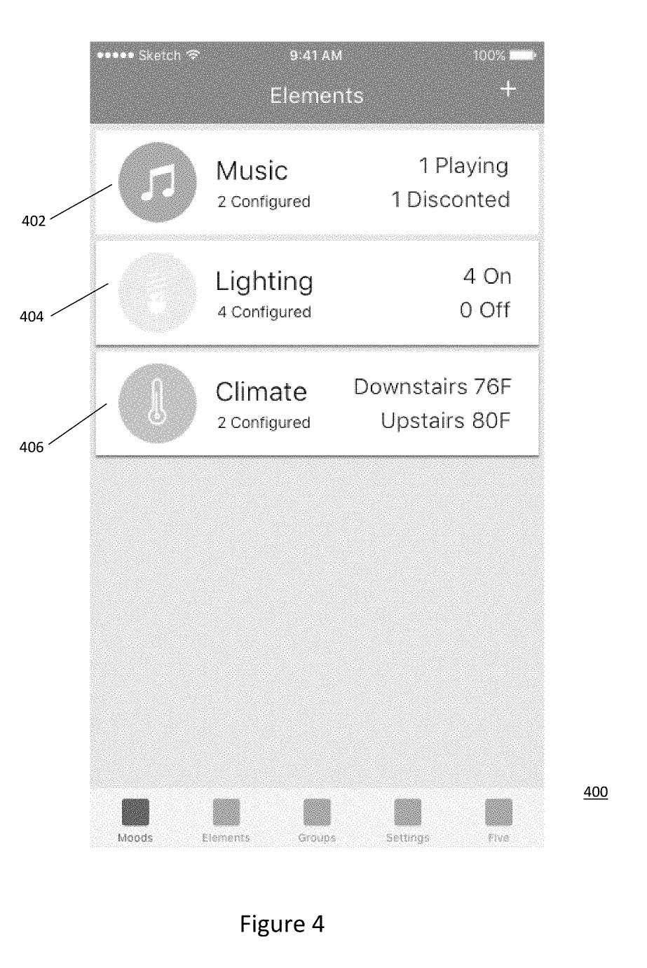

Turning now to FIG. 4, this figure presents a screen shot of the select mood function consistent with certain embodiments of the present invention. An important part of every experience is the mood to be created in the space as a portion of the defined experience. In this non-limiting example, a mood for a space may be defined by a user by selecting the music play list 402, one or more lighting configurations 404, and one or more climate settings 406 for the spaces in which the experience will be active. Upon completion of the selection of settings for each of these environmental choices, the user may save the mood to the system database. The mood may be retrieved at a future time and added to existing experiences or added to newly defined experiences based upon the needs of a user.

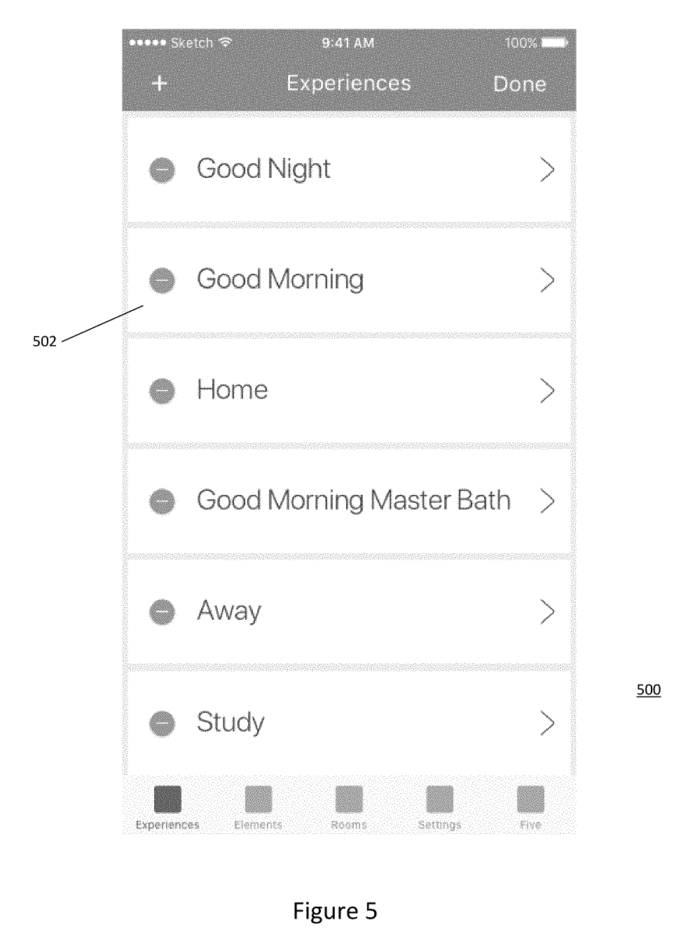

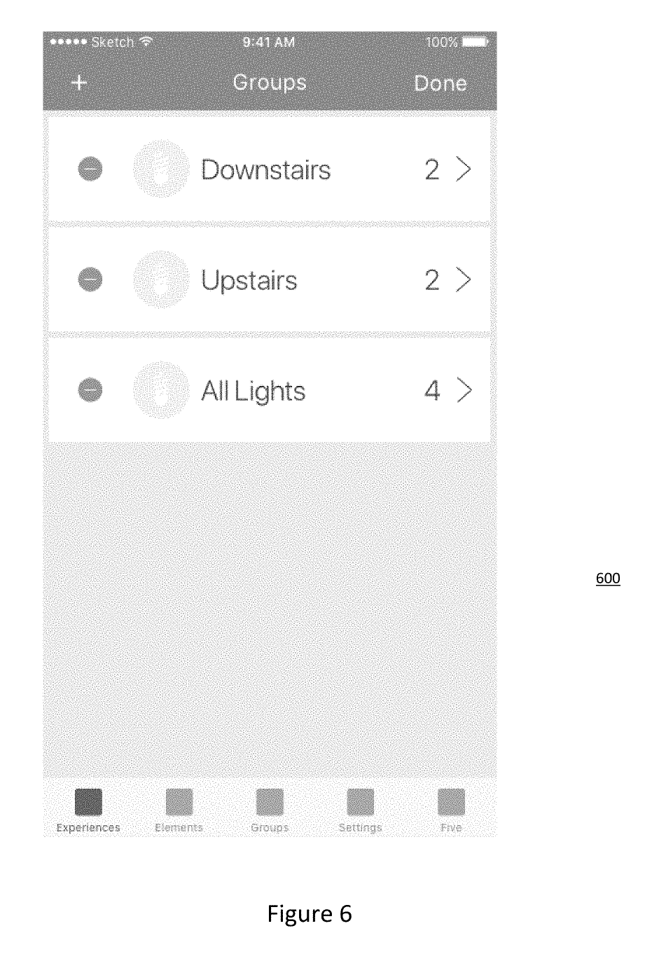

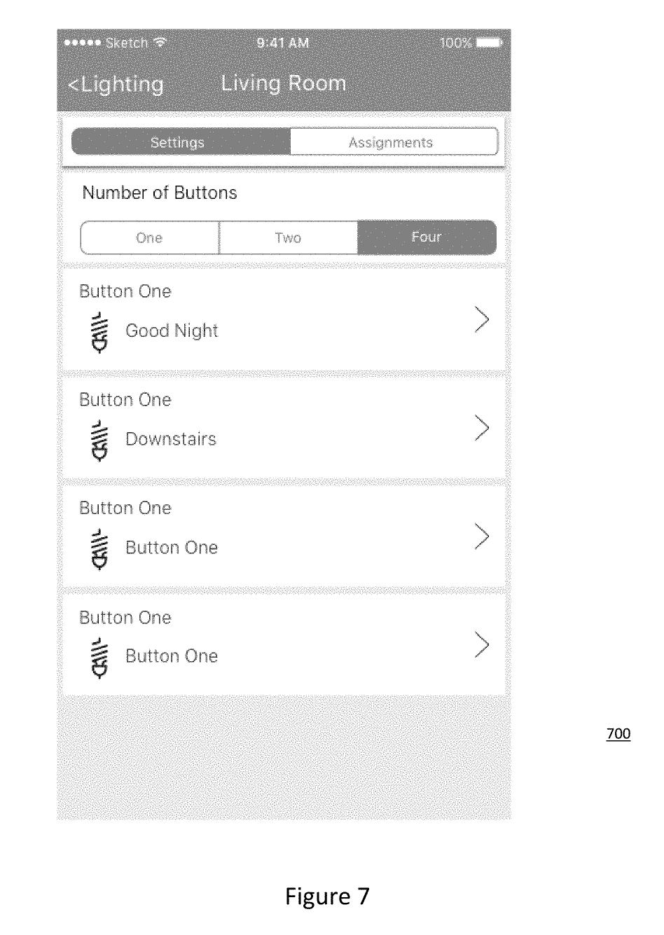

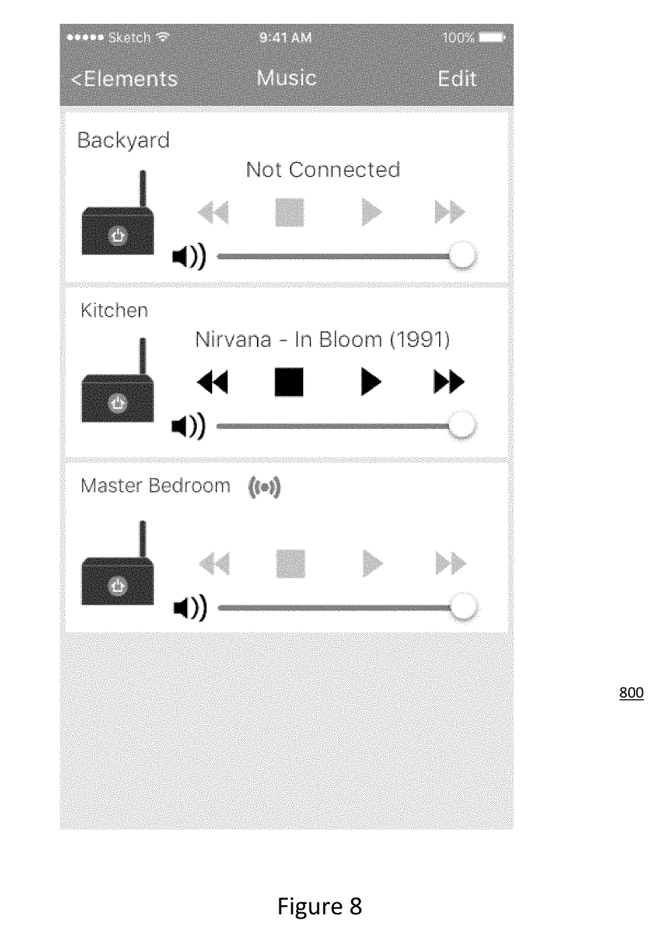

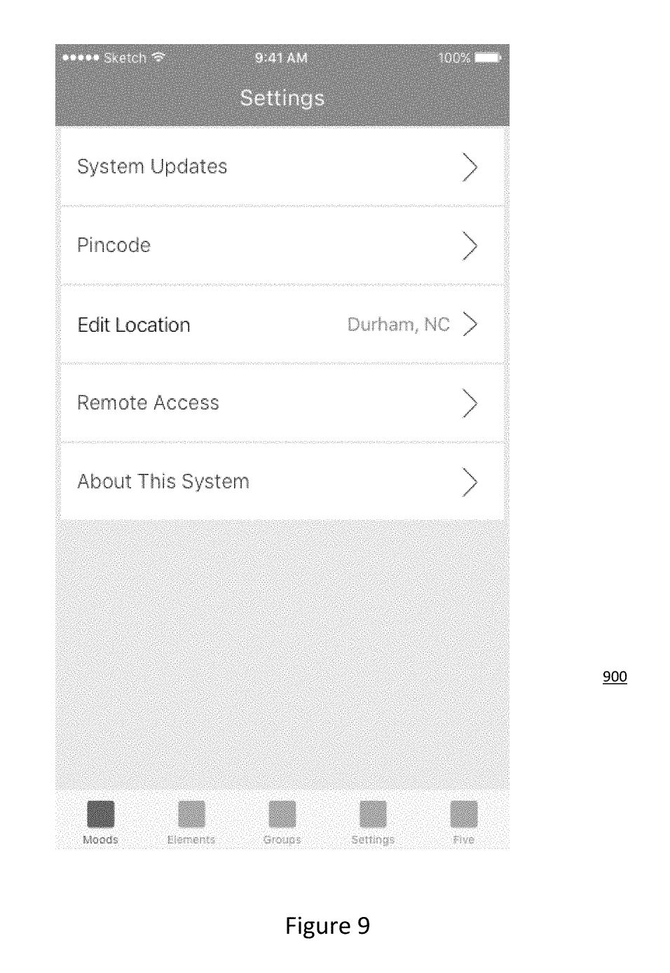

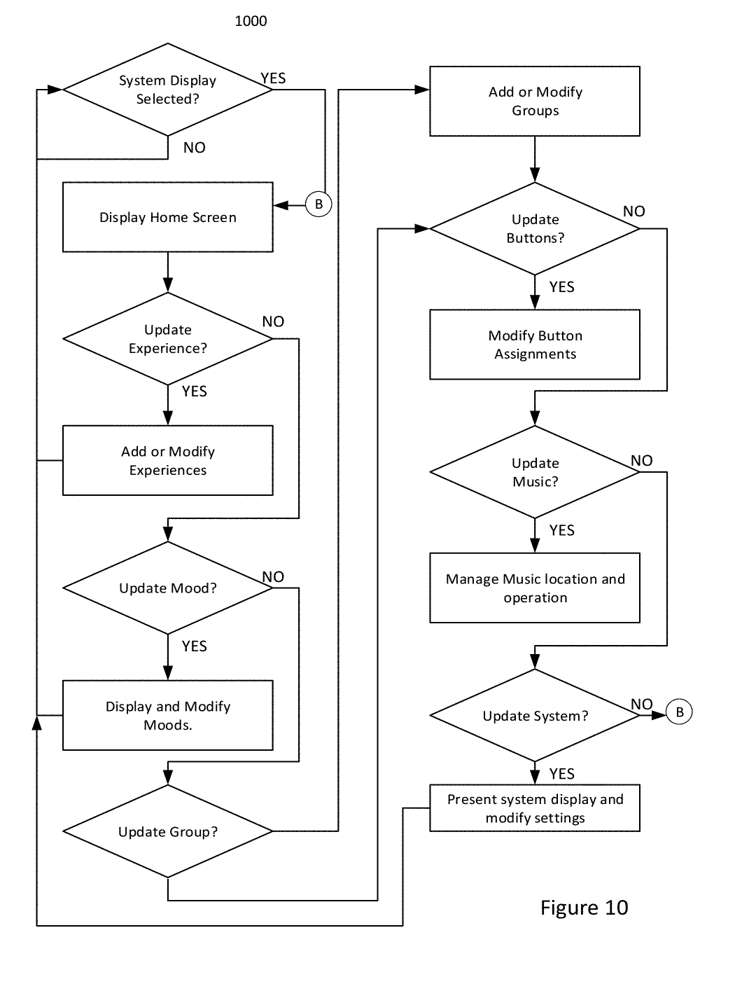

Turning now to FIG. 5, this figure presents a screen shot of the edit experience function consistent with certain embodiments of the present invention. In an embodiment, the user may be presented with a list of named experiences that have been configured and may be modified through the edit experience function 500. In a non-limiting example, a list of named experiences may be presented to the user 502. The user may select an experience by name 502 and modify the experience by changing the space, mood, lighting, music, climate, security, or any combination of elements that compose the experience selected.

Turning now to FIG. 6, this figure presents a screen shot of the edit group function consistent with certain embodiments of the present invention. In an embodiment, groups may be composed of multiple spaces, multiple areas, or multiple devices that may be combined together to be controlled by a single switch operation. Experiences may contain one or more groups such that when an experience is selected and initiated the group may be activated as a portion of that experience. This function permits a user to define or edit groups that have been defined 600. In a non-limiting example, a user may select the group from a list provided on the display. The group elements will be provided to the user (not shown) and the user may drag and drop elements to add to or retract from the group elements to create a modified group. The group may then be saved to the group definition database for inclusion with one or more experiences, or for later retrieval and use.

Turning now to FIG. 7, this figure presents a screen shot of the edit experience function consistent with certain embodiments of the present invention. In an embodiment, an electrical switch may have one, two or four buttons defined for the electrical switch and these assignments may be edited by a user to define or modify the activation experience associated with the selected button 700. In a non-limiting example, each button may be assigned to the activation circuit for an experience. In this example, the user may be presented with a display screen that provides the settings for each circuit associated with the electrical switch. An electrical switch in a particular space that is configured to control four electrical circuits may list the names of up to four experiences that have been defined as being activated by the electrical switch. The user may change any or all of the experiences assigned to the electrical switch by selecting the experience by name and placing that name onto the screen in the settings portion of the display. Alternatively, the user may select the Assignments tab on the display screen and define a new electric circuit or experience to be associated with an activation portion of the electrical switch.

Turning now to FIG. 8, this figure presents a screen shot of the edit music experience function consistent with certain embodiments of the present invention. In an embodiment, a user may be presented with a display identifying all music sources and the spaces that may be associated with the music source 800. In a non-limiting example, a user may be presented with a list of spaces in which music devices are present. The user may also be provided with a management function screen that displays in what space music may be active and provides controls for rewind, stop, play, and fast forward for each music device, as well as a listing of what music track may be playing in what space. The user may then utilize this display screen to control the music being played in each defined space by operating the controls on the display. The display, again, may be presented to a user on any mobile device display screen such as a computer, iPad, smart phone, tablet, smart watch, or any other device having a wireless connection capability and a display.

Turning now to FIG. 9, this figure presents a screen shot of the edit experience function consistent with certain embodiments of the present invention. In an embodiment, all system level settings and functions may be accessed by a user on this display screen 900. The system may be updated, security functions accessed, and remote access permitted through interaction with this screen display.

Turning now to FIG. 10, this figure presents a flow diagram of the user operation of the system consistent with certain embodiments of the present invention. In an embodiment, a user may initiate system operation and configuration by selecting the display operation on a mobile device such as a computer, iPad, tablet, smart phone, smart watch, or any other device capable of a wireless data connection with the system server 1000. Upon selection by the user, the system is active to display the Home screen to permit interaction with the system by the user. The user may select the option to permit the management of an experience. Management of experiences may include the addition, modification, deletion or amendment of the configuration of one or more experiences. Upon selection of an experience, the user is presented with the experiences display and the user may update the one or more experiences as desired.

If the user does not select the update experience action, the user may instead select the update mood option. Upon selection of the update mood option, the user may be presented with a display of moods already configured in the system. The user may have access to the mood display to perform management of the moods, where management may be composed of addition, deletion, modification or amendment of named moods and the components of the one or more moods. The user then selects a mood and/or a component of a mood to perform management of the one or more moods. Alternatively, the user may define and name a new mood that is then saved to the system database for later action and/or inclusion in an experience.

If the user does not select the update mood action, the user may instead choose the update group option. As described above, a group may be composed of groups of spaces, items, and/or devices. A user will be presented with access to the list of groups. The user may select a group and manage the group, where management of the group is composed of actions previously described above. Alternatively, the user may define a new group that is then saved to the system database for later action or for retrieval and use in a mood or experience either newly created or modified for user preferences.

If the user does not select the update group option, the user may instead select the update light switch option. In an embodiment, light switches may have one, two, or four electrical circuit connections. The light switch may initiate a mood, experience, start a device, or perform other initiation actions by associating the mood, experience, device, or other action with an electrical circuit connection. The user may be presented with a display that provides the configuration information for each electrical switch and the user may modify the association of the electrical circuit with a particular action, mood or experience to change the action that occurs when a user selects the portion of the electrical switch that is connected to a particular electrical circuit. The portions of the electrical switch, called buttons, may be assigned to particular actions with one, two or four different actions controlled by a single electrical switch based upon the configuration choices input by one or more users.

If the user does not select the update light switch option, the user may instead select the control music option. As previously discussed, the user may then be presented with a display having the spaces in which music devices are located as well as the control options to permit the user to know what music is currently being played and permit the user to reconfigure the music in different spaces, or control the music being played in any selected space.

If the user does not select the control music option, the user may be presented with the update system display option. The update system display permits a user to access and manage all of the system control options such as, in a non-limiting example, system updates, the pincode for access to the system controls, editing the location of the system, permitting remote access, and other options at a system level. The processor may then return to the wait state at 1000 to await additional action by a user.

While certain illustrative embodiments have been described, it is evident that many alternatives, modifications, permutations and variations will become apparent to those skilled in the art in light of the foregoing description.

We claim:

1. A system for controlling multiple electric circuits, comprising:
an electrical switch having one or more control sections;
at least one electrical circuit or electrically controlled device assigned to said one or more control sections;
a control module associated with said electrical switch and having a user accessible control capability available to the user through a user interface configured in an electronic device separate from said electrical switch;
assigning one or more devices, one or more experiences, and/or one or more triggers to each one of said one or more control sections;
initiating the operation of said one or more devices, one or more experiences, and/or one or more triggers when a user interacts with the associated control section on the electrical switch.

2. The system of claim 1, where the electrical switch may have one, two, or four control sections.

3. The system of claim 1, where the at least one electrical circuit is a wired connection to the electrical switch.

4. The system of claim 1, where said one or more devices include an audio device, a video device, a computing device, a security device, a household appliance, a lighting device, a home automation device, or any other device specified for use in a space associated with said user's domicile.

5. The system of claim 1, where said one or more experiences include moods and experiences defined by the system or by said user and operational within a space associated with said user's domicile when initiated.

6. The system of claim 1, where said one or more triggers include start and stop times for the initiation and cessation of operation of all devices and experiences associated with a selected control section.

7. The system of claim 1, further comprising configuring all of said one or more devices, said one or more experiences, and said one or more triggers through a user interface displayed on, and controlled by, said electronic device.

8. The system of claim 1, where said electronic device is a mobile device, iPad, computer, electronic controller, smart phone, smart watch, or any other electronic device having a processor, display, and wired or wireless communication capability.

9. A method for controlling multiple electric circuits, comprising:
assigning at least one electrical circuit or electrically controlled device to one or more control sections;
associating a control module with an electrical switch and having a user accessible control capability available to the user through a user interface configured in an electronic device separate from said electrical switch;
assigning one or more devices, one or more experiences, and/or one or more triggers to each one of said one or more control sections;
initiating the operation of said one or more devices, one or more experiences, and/or one or more triggers when a user interacts with the associated control section on the electrical switch.

10. The method of claim 9, where the electrical switch may have one, two, or four control sections.

11. The method of claim 9, where the at least one electrical circuit is a wired connection to the electrical switch.

12. The method of claim 9, where said one or more devices include an audio device, a video device, a computing device, a security device, a household appliance, a lighting device, a home automation device, or any other device specified for use in a space associated with said user's domicile.

13. The method of claim 9, where said one or more experiences include moods and experiences defined by the system or by said user and operational within a space associated with said user's domicile when initiated.

14. The method of claim 9, where said one or more triggers include start and stop times for the initiation and cessation of operation of all devices and experiences associated with a selected control section.

15. The method of claim 9, further comprising configuring all of said one or more devices, said one or more experiences, and said one or more triggers through a user interface displayed on, and controlled by, said electronic device.

16. The method of claim 9, where said electronic device is a mobile device, iPad, computer, electronic controller, smart phone, smart watch, or any other electronic device having a processor, display, and wired or wireless communication capability.
